(19) United States
(12) Patent Application Publication
(10) Pub. No.: US 2014/0064529 A1
(43) Pub. Date: Mar. 6, 2014

(54) APPARATUS AND METHOD OF SHIELDING EXTERNAL NOISE FOR USE IN HEARING AID DEVICE

(71) Applicant: ALGOR KOREA CO., LTD., Gwangju (KR)

(72) Inventor: Dong Soo JANG, Gwangju (KR)

(73) Assignee: ALGOR KOREA CO., LTD., Gwangju (KR)

(21) Appl. No.: 13/672,360

(22) Filed: Nov. 8, 2012

(30) Foreign Application Priority Data
Aug. 29, 2012 (KR) 10-2012-0094720

(51) Int. Cl. H04R 25/00

(52) U.S. Cl. CPC H04R 25/505
USPC 381/317

(57) ABSTRACT

Provided is an external noise shielding apparatus and method for use in a hearing aid device. The external noise shielding apparatus and method periodically monitors and shields external noise introduced into the hearing aid device to thus enable a user to discernibly hear a voice signal even in the external noise environment.

### BACKGROUND OF THE INVENTION

1. Field of the Invention

The present invention relates to an apparatus and method of shielding external noise for use in a hearing aid device, and more particularly, to an external noise shielding apparatus and method for use in a hearing aid device, in which noise introduced into the inside of the hearing aid device from the outside thereof is periodically monitored and then shielded, to thereby allow voice signals to be clearly heard despite the external noise.

2. Description of the Related Art

Hearing aid devices are auxiliary devices that assist persons having difficulties in hearing to hear external sounds well.

FIG. 1 is a block diagram schematically showing a configuration of a conventional digital hearing aid device.

As shown in FIG. 1, a digital hearing aid device includes: a microphone M that converts an external sound into an electrical signal; an amplification unit D that amplifies the electrical signal output from the microphone M; and a receiver R that outputs the electrical signal amplified from the amplification unit D as the external sound.

In addition, the digital hearing aid device includes a switch S that is an operation state change-over switch for the amplification unit D to thus enable a user to control an amplification factor that indicates how many times the amplification unit D amplifies a signal, according to user's hearing.

The switch S may be configured into a variable resistor type volume control unit or a memory change digital button switch, but is not limited thereto.

Typically, in the case of the hearing aid devices called hearing aids, as external noise becomes large, voice signals are drowned in the external noise, to thereby cause a listener to fail to hear caller's voices, that is, voice signals, and to thus cause a problem of degrading articulation of a voice that is the sound of a word. A frequency spectrum of the external noise changes from time to time according to lapse of time. Accordingly, even though noise removal algorithms are optimally implemented, digital hearing aids may suffer from physical limits to discriminate a voice from noise.

FIG. 2 is a graphical view showing a typical external noise amplitude spectrum illustrated in a thick curve, and a voice amplitude spectrum illustrated in a thin curve.

In FIG. 2, a difference between a voice curve and a noise curve represents a value that is obtained by subtracting the magnitude of the external noise amplitude spectrum from that of the voice amplitude spectrum, at a given frequency. Here, the voice means a sound that is created by the vocal organs. If the difference is a big positive value, it indicates that a voice component is strong at a certain frequency. Conversely, if the difference is a small positive value, or a big negative value, it indicates that an external noise component is strong at a certain frequency. The magnitude of the external noise becomes large as the frequency of the noise signal becomes higher, but the magnitude of the voice becomes small as the frequency of the voice signal becomes higher. As a result, in the case of a particular voice having a high frequency, voice discrimination may be significantly lowered due to external noise.

### SUMMARY OF THE INVENTION

To overcome problems or inconveniences of a hearing aid device according to the conventional art, it is an object of the present invention to provide an external noise shielding apparatus and method for use in a hearing aid device, in which voice discrimination of caller's voices may be improved by monitoring and shielding external noise as needed or from time to time by utilizing a toggle switch of a memory button that is attached to a digital hearing aid device, or by utilizing a timer of a digital signal processor (DSP) integrated circuit (IC) chip that is built in the digital hearing aid device.

Other objects of the present invention are not limited to the above-mentioned object, but it will be obvious to those who are skilled in the art that the other objects will be clearly understood from the following description.

To accomplish the above object of the present invention, according to an aspect of the present invention, there is provided an external noise shielding apparatus for use in a hearing aid device, the external noise shielding apparatus comprising:

a microphone (100) that receives an external sound;

a digital signal processor (DSP) integrated circuit (IC) amplifier unit (200) that amplifies the external sound received from the microphone (100);

a receiver (400) that outputs the external sound from which the external noise is removed;

a digital memory toggle button switch (300) for a change of status of the digital signal processor (DSP) integrated circuit (IC) amplifier unit (200); and

a power supply for supplying power to the microphone (100), the digital signal processor (DSP) integrated circuit (IC) amplifier unit (200), the receiver (400), and the digital memory toggle button switch (300), wherein the digital signal processor (DSP) integrated circuit (IC) amplifier unit (200) comprises:

a timer (230) that counts a predetermined time;

an analog-to-digital (AD) converter (210) that converts an externally input analog signal into a digital signal for digital signal processing;

an input buffer memory (220) that temporarily stores the digital signal;

a fast Fourier transformer (FFT) (240) that fast-Fourier-transforms the digital signal output from the input buffer memory (220);

an equalizer (250) that emphasizes a low voice or a high voice;

an inverse fast Fourier transformer (iFFT) (260) that inversely fast-Fourier-transforms amplitude spectrum data of a decibel (dB) unit back into that of a linear unit;

an output buffer memory (270) that temporarily stores data output from the inverse fast Fourier transformer (iFFT) (260);

a digital-to-analog (DA) converter (280) that converts the digital data output from the output buffer memory (270) back into the analog signal.

According to another aspect of the present invention, there is provided an external noise shielding method for use in a hearing aid device, the external noise shielding method comprising:

a noise spectrum subtracted signal temporary storing step in which an incoming signal input from a microphone (100) is analog-to-digital converted by an analog-to-digital (AD) converter (210) and stored in an input buffer memory (220), the digital signal is fast-Fourier-transformed by a fast Fourier transformer (FFT) (240), the fast-Fourier-transformed signal is stored as the N quantities of complex data, only an amplitude component is calculated separately from the N amounts of complex data, an amplitude spectrum of a linear unit is transformed into the amplitude spectrum of a decibel (dB) unit, to thus obtain the N/2 quantities of the dB converted amplitude spectrum, and the obtained N/2 quantities of the dB converted amplitude spectrum is averaged into a noise spectrum for a period of time that is set in a timer (230) of a digital signal processor (DSP) integrated circuit (IC) amplifier unit (200) to thus temporarily store the noise spectrum, or the obtained N/2 quantities of the dB converted amplitude spectrum is averaged into a noise spectrum for a period of time whenever a user presses a digital memory toggle button switch (300), to thus temporarily store a signal that is obtained by subtracting the noise spectrum from a noise plus voice signal;

a gain changing step in which the previously temporarily stored noise spectrum is subtracted from the noise plus voice spectrum that is continuously calculated and created in real-time, and a gain is changed through an operation of ascending or descending an amplitude in each frequency in the noise shielded voice spectrum;

a maximum output limit setting step in which the gain changed amplitude spectrum is equalized in a low or high band by an equalizer (250) depending on user's preference after the amplitude spectrum gain has been changed, and a maximum output is limited and set differently in each frequency in a manner that the equalized signal is not too greatly amplified to avoid distortion of a receiver (400) considering the maximum output of the receiver (400) after having passed through the equalizer (250); and

a noise shielded and voice amplified signal outputting step in which the amplitude spectrum of the dB unit is inversely transformed back into the amplitude spectrum of the linear unit, the amplitude spectrum of the linear unit is inversely fast-Fourier-transformed from a frequency domain to a time domain by an inverse fast Fourier transformer (iFFT) (260), to then be temporarily stored in an output buffer memory (270), the inverse fast Fourier transformed signal is sequentially digital-to-analog converted by a digital-to-analog (DA) converter (280) to then be output via a receiver (400), thereby outputting an optimal signal via the receiver (400) in which noise is shielded and only a voice is amplified.

Preferably but not necessarily, the gain changing step comprises improving voice discrimination by outputting an optimal voice differently amplified in each frequency according to user's hearing threshold of a user who uses a digital hearing aid device.

According to still another aspect of the present invention, there is provided an external noise shielding method for use in a hearing aid device in which a voice is compared with noise to thus shield the noise, the external noise shielding method comprising the steps of:

judging that a voice level is large since a voice signal is significantly larger than a noise signal if the current input level is greater by 10 dB or more than the noise level to thus not reduce noise, and judging that a noise level is large since the noise signal is significantly larger than the voice signal if the current input level is not greater by 10 dB or more than the noise level to thus reduce noise;

reducing the voice level by zero (0) dB since the voice level is larger by 10 dB than the noise level if a difference between the voice and the noise is 10 dB, that is, diff=10 dB, and reducing the voice level by five (5) dB since the voice level is larger by 5 dB than the noise level if diff=5 dB; and

reducing the voice level by ten (10) dB since the voice level is equal to the noise level if diff=0 dB, and reducing the voice level by fifteen (15) dB since the noise level is larger by 5 dB than the voice level if diff=−5 dB.

### BRIEF DESCRIPTION OF THE DRAWINGS

The above and/or other aspects of the present invention will become apparent and more readily appreciated from the following description of the exemplary embodiments, taken in conjunction with the accompanying drawings in which:

FIG. 1 is a block diagram schematically showing a configuration of a conventional digital hearing aid device;

FIG. 2 is a graphical view showing a typical external noise amplitude spectrum illustrated in a thick curve, and a voice amplitude spectrum illustrated in a thin curve.

FIG. 3 is a block diagram schematically showing a configuration of an external noise shielding method for use in a hearing aid device according to the present invention; and

FIG. 4 is a flowchart view illustrating a process of subtracting a noise spectrum from a noise plus voice spectrum of FIG. 3, in detail.

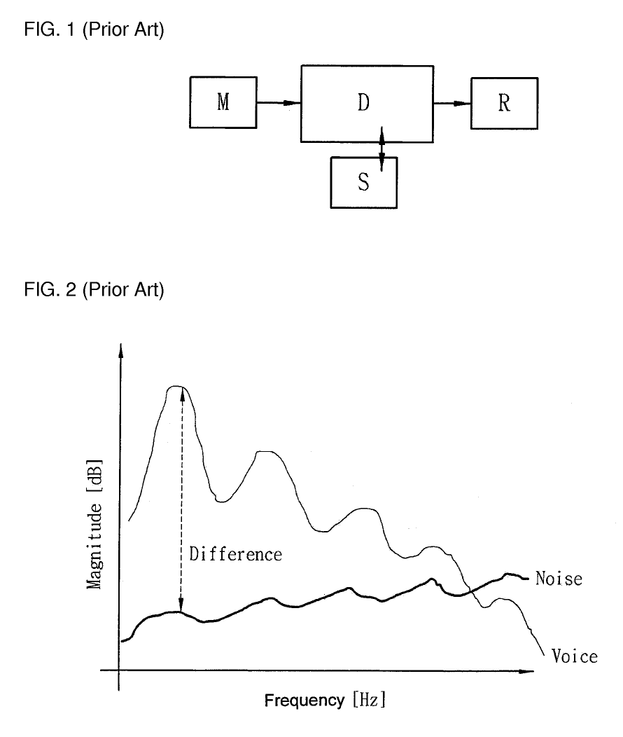

### DETAILED DESCRIPTION OF THE INVENTION

The nature, advantages and various additional features of the invention will appear more fully upon consideration of the illustrative embodiments now to be described in detail with the accompanying drawings. However, the present invention is not limited to the following embodiments but will be embodied in various forms.

That is, the embodiments of the present invention play a role of making the disclosure of the present invention perfect, and are provided to inform a person who has an ordinary knowledge and skill in a technological field to which this invention belongs. This invention should be defined based on the scope of claims.

An external noise shielding apparatus and method for use in a hearing aid device will now be described with reference to the accompanying drawings. Like numbers refer to like elements throughout the description of the present invention.

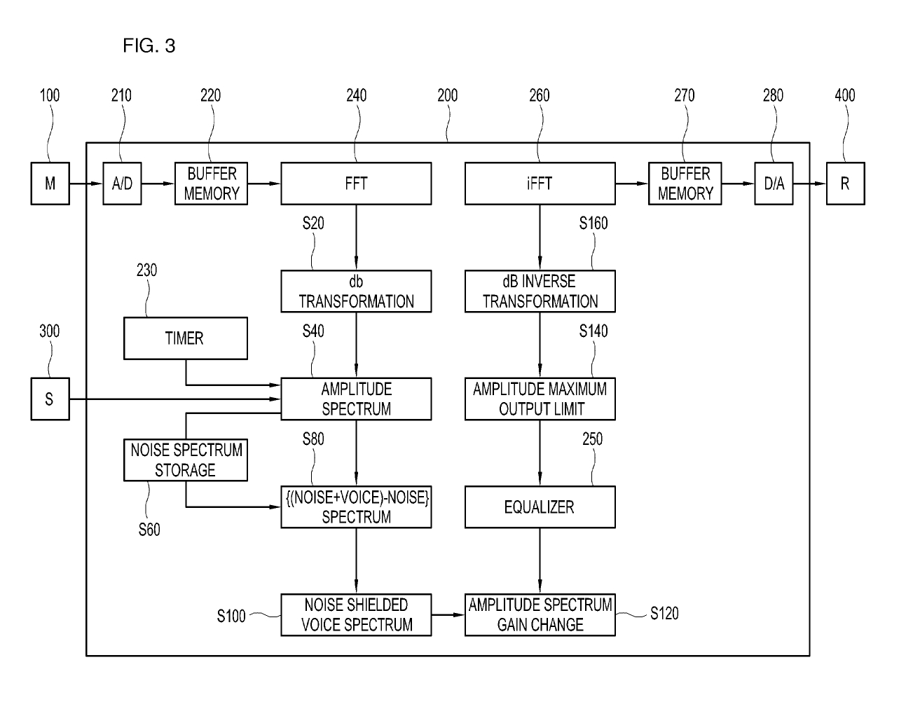

FIG. 3 is a block diagram schematically showing a configuration of an external noise shielding method for use in a hearing aid device according to the present invention.

As shown in FIG. 3, the external noise shielding apparatus includes: a microphone 100 that receives an external sound; a digital signal processor (DSP) integrated circuit (IC) amplifier unit 200 that amplifies the external sound received from the microphone 100; a receiver 400 that outputs the external sound from which the external noise is removed; a digital memory toggle button switch 300 for a change of status of the digital signal processor (DSP) integrated circuit (IC) amplifier unit 200; and a power supply (not shown) for supplying power to the microphone 100, the digital signal processor (DSP) integrated circuit (IC) amplifier unit 200, the receiver 400, and the digital memory toggle button switch 300.

In addition, as shown in FIG. 3, the digital signal processor (DSP) integrated circuit (IC) amplifier unit 200 includes: a timer 230 that counts a predetermined time; an analog-to-digital (AD) converter 210 that converts an externally input analog signal into a digital signal for digital signal processing; an input buffer memory 220 that temporarily stores the digital signal; a fast Fourier transformer (FFT) 240 that fast-Fourier-transforms the digital signal output from the input buffer memory 220; an equalizer 250 that emphasizes a low voice or a high voice; an inverse fast Fourier transformer (iFFT) 260 that inversely fast-Fourier-transforms amplitude spectrum data of a decibel (dB) unit back into that of a linear unit; an output buffer memory 270 that temporarily stores data output from the inverse fast Fourier transformer (iFFT) 260; a digital-to-analog (DA) converter 280 that converts the digital data output from the output buffer memory 270 back into the analog signal.

An operation of an external noise shielding apparatus for use in a hearing aid device according to an embodiment of the present invention having the above-described configuration will be described below.

An incoming signal input from a microphone 100 is analog-to-digital converted by an analog-to-digital (AD) converter 210 and stored in an input buffer memory 220. The digital signal is fast-Fourier-transformed by a fast Fourier transformer (FFT) 240. The fast-Fourier-transformed signal is stored as the N quantities of complex data. Only an amplitude component is calculated separately from the N amounts of complex data, and then an amplitude spectrum of a linear unit is transformed into the amplitude spectrum of a decibel (dB) unit in step S20. The N/2 quantities of the dB converted amplitude spectrum in step S20 are obtained in step S40. The obtained N/2 quantities of the dB converted amplitude spectrum is averaged into a noise spectrum for a period of time that is set in a timer 230 of a digital signal processor (DSP) integrated circuit (IC) amplifier unit 200 and thus the averaged noise spectrum is temporarily stored in step S60. Otherwise, the obtained N/2 quantities of the dB converted amplitude spectrum is averaged into a noise spectrum for a period of time whenever a user presses a digital memory toggle button switch 300 and thus a signal that is obtained by subtracting the averaged noise spectrum from a noise plus voice signal output from step S40 in step S80 is temporarily stored in step S100.

In other words, the amplitude spectrum that is output from step S40 and that is continuously calculated and created in real-time, is a noise plus voice spectrum. The, the previously temporarily stored noise spectrum of step S60 is subtracted from the noise plus voice spectrum of step S40 in step S80. The noise shielded amplitude spectrum becomes a noise shielded voice spectrum, in which a voice component is relatively emphasized in comparison with a noise component in step S100.

A gain is changed through an operation of ascending or descending an amplitude in each frequency in the noise shielded voice spectrum. In this process, voice discrimination is improved by outputting an optimal voice differently amplified in each frequency according to user's hearing threshold of a user who uses a digital hearing aid device in step S120.

The gain changed amplitude spectrum is equalized in a low or high band by an equalizer 250 depending on user's preference after the amplitude spectrum gain has been changed.

A maximum output of the receiver 400 is limited and set differently in each frequency in a manner that the equalized signal is not too greatly amplified to avoid distortion of a receiver 400 considering the maximum output of the receiver 400 after having passed through the equalizer 250 in step S140. In addition, the amplitude spectrum of the dB unit is inversely transformed back into the amplitude spectrum of the linear unit in step S160. The amplitude spectrum of the linear unit is inversely fast-Fourier-transformed from a frequency domain to a time domain by an inverse fast Fourier transformer (iFFT) 260, to then be temporarily stored in an output buffer memory 270. The inverse fast Fourier transformed signal is sequentially digital-to-analog converted by a digital-to-analog (DA) converter 280 to then be output via a receiver 400, thereby outputting an optimal signal via the receiver 400 in which noise is shielded and only a voice is amplified.

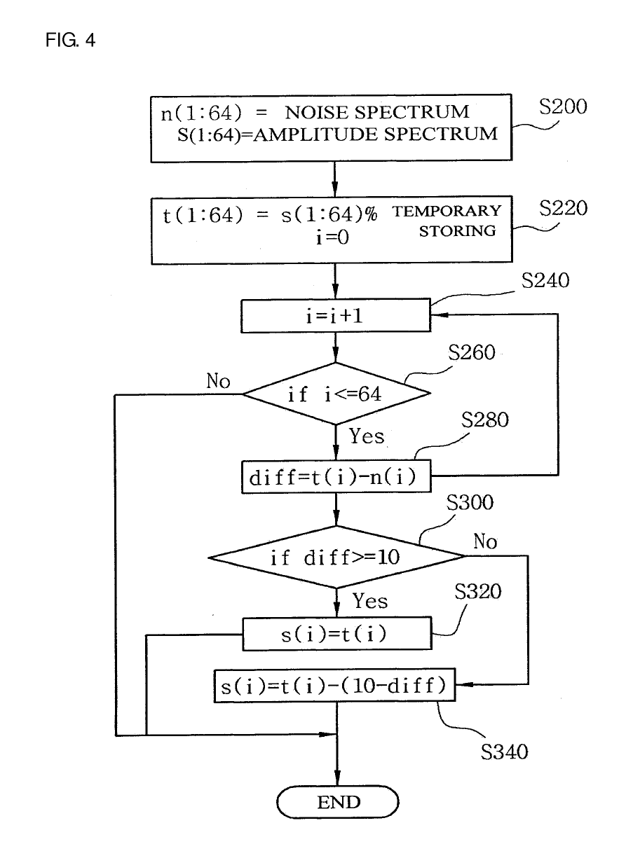

FIG. 4 is a flowchart view illustrating a process of subtracting a noise spectrum from a noise plus voice spectrum of FIG. 3, in detail. In FIG. 4, according to an embodiment of the present invention, a frequency interval of a frequency spectrum is sixty-four (64) and a noise shielding margin is 10 dB.

In FIG. 4, when a frequency interval of a frequency spectrum is sixty-four (64), one hundred twenty-eight (128) pieces of data is FFT (Fast Fourier Transform) signal processed. In FIG. 4, n(1:64) represents a noise amplitude spectrum, that is, a noise spectrum storing process of FIG. 3, and s(1:64) represents a current input noise plus voice amplitude spectrum, that is, an amplitude spectrum of FIG. 3. The s(1:64) is temporarily stored in a buffer memory of t(1:64), and then represents that a noise shielded final result, that is, a noise shielded voice spectrum of FIG. 3 is stored.

In the present invention, the noise shielded margin is set as 10 dB, but is not limited thereto. Those skilled in the art may change the noise shielded margin appropriately.

The present invention may be configured by considering that if a noise shielded margin is raised by 10 dB or more due to severe ambient noise, a voice is also shielded, and as a result, although the noise is significantly decreased, the voice is also decreased to thus cause voice discrimination to be weakened. On the contrary, the present invention may be configured by considering that if a noise shielded margin is reduced by 10 dB or more, relatively less noise is removed. Thus, the present invention may be implemented to allow a user to adjust up and down a noise shielded margin depending upon an ambient noise environment via the above-described digital memory toggle button switch 300.

In addition, in the case that an interval of a frequency spectrum is sixty-four (64), a half of a sampling frequency of 16 kHz is 8 kHz and is divided into sixty-four (64) frequencies. As a result, a frequency resolution becomes 8000/64, that is, 125 Hz.

If a frequency resolution is heightened, noise may be reduced minutely by analyzing a noise spectrum minutely. However, a central processing unit (CPU) is excessively overloaded to thus cause much power consumption. In the present invention, the interval of the frequency spectrum is divided into sixty-four frequencies depending upon performance of the digital signal processor (DSP) integrated circuit (IC) amplifier unit 200. This may be also changed depending upon performance of a processor to be used.

Steps S200 to S340 of FIG. 4 will be described as follows.

It is judged that a voice level is large since a voice signal is significantly larger than a noise signal if the current input level is greater by 10 dB or more than the noise level to thus not reduce noise. On the contrary, it is judged that a noise level is large since the noise signal is significantly larger than the voice signal if the current input level is not greater by 10 dB or more than the noise level to thus reduce noise.

Meanwhile, the voice level is reduced by zero (0) dB since the voice level is larger by 10 dB than the noise level if a difference between the voice and the noise is 10 dB, that is, diff=10 dB, and the voice level is reduced by five (5) dB since the voice level is larger by 5 dB than the noise level if diff=5 dB.

In addition, the voice level is reduced by ten (10) dB since the voice level is equal to the noise level if diff=0 dB, and the voice level is reduced by fifteen (15) dB since the noise level is larger by 5 dB than the voice level if diff=−5 dB.

The process of FIG. 4 will be described below in more detail.

The noise amplitude spectrum n(1:64) and the voice amplitude spectrum s(1:64) are stored in step S200. Subsequently, the channel number i is temporarily stored as zero (0), that is, i=0 from among the spectrums 1:64 in step S220.

Then, the current channel number i of the spectrum is stored as i+1, that is, one channel number is added to the previous channel number such as i=i+1 in step S240. Then, it is confirmed whether or not the channel number is equal to or less than 64 in step S260. Then, a difference between the stored voice spectrum and the current noise spectrum at the current channel i, that is, diff=t(i)−n(i) is acquired in step S280. Then, it is confirmed whether or not diff≧10 in step S300. If it is judged that diff≧10, the stored voice spectrum of the current channel is transferred to a memory space of the voice spectrum of the current channel.

In other words, s(i)=t(i) in step S320, and then the process is ended. If the channel is more than 64 in step S260, the process is ended. If diff=t(i)−n(i) is acquired in step S280, the process goes to step S300 and simultaneously returns back to step S240.

Next, if it is confirmed that diff<10 in step S300, in other words, if it is judged as a negative result, a result that is obtained by subtracting {10 dB−(a difference between the stored voice spectrum and the current noise spectrum at the current channel)} from the stored voice spectrum of the current channel, is transferred to the memory space of the voice spectrum of the current channel in step S340.

In other words, s(i)=t(i)−(10-diff).

### The Effect of the Invention

According to the present invention described until now, a user who uses a digital hearing aid device may hear a sound in which external noise is shielded and a voice is relatively emphasized and amplified. As a result, voice discrimination may be enhanced.

As described above, the present invention has been described with respect to particularly preferred embodiments. However, the present invention is not limited to the above embodiments, and it is possible for one who has an ordinary skill in the art to make various modifications and variations, without departing off the spirit of the present invention. Thus, the protective scope of the present invention is not defined within the detailed description thereof but is defined by the claims to be described later and the technical spirit of the present invention.

What is claimed is:

1. A hearing aid device comprising: a microphone that receives an external sound;
a digital signal processor (DSP) integrated circuit (IC) amplifier unit that amplifies the external sound received from the microphone;
a receiver that outputs the external sound from which the external noise is removed;
a digital memory toggle button switch for a change of status of the digital signal processor (DSP) integrated circuit (IC) amplifier unit; and
a power supply for supplying power to the microphone, the digital signal processor (DSP) integrated circuit (IC) amplifier unit, the receiver, and the digital memory toggle button switch, wherein the digital signal processor (DSP) integrated circuit (IC) amplifier unit comprises:
a timer that counts a predetermined time;
an analog-to-digital (AD) converter that converts an externally input analog signal into a digital signal for digital signal processing;
an input buffer memory that temporarily stores the digital signal;
a fast Fourier transformer (FFT) that fast-Fourier-transforms the digital signal output from the input buffer memory;
an equalizer that emphasizes a low voice or a high voice;
an inverse fast Fourier transformer (iFFT) that inversely fast-Fourier-transforms amplitude spectrum data of a decibel (dB) unit back into that of a linear unit;
an output buffer memory that temporarily stores data output from the inverse fast Fourier transformer (iFFT);
a digital-to-analog (DA) converter that converts the digital data output from the output buffer memory back into the analog signal.

2. An external noise shielding method for use in a hearing aid device, the external noise shielding method comprising:
a noise spectrum subtracted signal temporary storing step in which an incoming signal input from a microphone is analog-to-digital converted by an analog-to-digital (AD) converter and stored in an input buffer memory, the digital signal is fast-Fourier-transformed by a fast Fourier transformer (FFT), the fast-Fourier-transformed signal is stored as the N quantities of complex data, only an amplitude component is calculated separately from the N amounts of complex data, an amplitude spectrum of a linear unit is transformed into the amplitude spectrum of a decibel (dB) unit, to thus obtain the N/2 quantities of the dB converted amplitude spectrum, and the obtained N/2 quantities of the dB converted amplitude spectrum is averaged into a noise spectrum for a period of time that is set in a timer of a digital signal processor (DSP) integrated circuit (IC) amplifier unit to thus temporarily store the noise spectrum, or the obtained N/2 quantities of the dB converted amplitude spectrum is averaged into a noise spectrum for a period of time whenever a user presses a digital memory toggle button switch, to thus temporarily store a signal that is obtained by subtracting the noise spectrum from a noise plus voice signal;
a gain changing step in which the previously temporarily stored noise spectrum is subtracted from the noise plus voice spectrum that is continuously calculated and created in real-time, and a gain is changed through an operation of ascending or descending an amplitude in each frequency in the noise shielded voice spectrum;
a maximum output limit setting step in which the gain changed amplitude spectrum is equalized in a low or high band by an equalizer depending on user's preference after the amplitude spectrum gain has been changed, and a maximum output is limited and set differently in each frequency in a manner that the equalized signal is not too greatly amplified to avoid distortion of a receiver considering the maximum output of the receiver after having passed through the equalizer; and
a noise shielded and voice amplified signal outputting step in which the amplitude spectrum of the dB unit is inversely transformed back into the amplitude spectrum of the linear unit, the amplitude spectrum of the linear unit is inversely fast-Fourier-transformed from a frequency domain to a time domain by an inverse fast Fourier transformer (iFFT), to then be temporarily stored in an output buffer memory, the inverse fast Fourier transformed signal is sequentially digital-to-analog converted by a digital-to-analog (DA) converter to then be output via a receiver, thereby outputting an optimal signal via the receiver in which noise is shielded and only a voice is amplified.

3. The external noise shielding method of claim 2, wherein the gain changing step comprises improving voice discrimination by outputting an optimal voice differently amplified in each frequency according to user's hearing threshold of a user who uses a digital hearing aid device.

4. An external noise shielding method for use in a hearing aid device in which a voice is compared with noise to thus shield the noise, the external noise shielding method comprising the steps of:
judging that a voice level is large since a voice signal is significantly larger than a noise signal if the current input level is greater by 10 dB or more than the noise level to thus not reduce noise, and judging that a noise level is large since the noise signal is significantly larger than the voice signal if the current input level is not greater by 10 dB or more than the noise level to thus reduce noise;
reducing the voice level by zero (0) dB since the voice level is larger by 10 dB than the noise level if a difference between the voice and the noise is 10 dB, that is, diff=10 dB, and reducing the voice level by five (5) dB since the voice level is larger by 5 dB than the noise level if diff=5 dB; and
reducing the voice level by ten (10) dB since the voice level is equal to the noise level if diff=0 dB, and reducing the voice level by fifteen (15) dB since the noise level is larger by 5 dB than the voice level if diff=−5 dB.
